(19) United States
(12) Patent Application Publication
(10) Pub. No.: US 2018/0174169 A1
(43) Pub. Date: Jun. 21, 2018

(54) SYSTEM AND METHOD FOR ANALYZING PATRON SATISFACTION DATA

(71) Applicant: 9120-6094 Quebec Inc., Mount Saint Hilaire (CA)

(72) Inventors: Christian Watier, Beloeil (CA); Luc Brousseau, Beloeil (CA)

(73) Assignee: 9120-6094 Quebec Inc., Mount Saint Hilaire (CA)

(21) Appl. No.: 15/850,900

(22) Filed: Dec. 21, 2017

Related U.S. Application Data
(60) Provisional application No. 62/437,408, filed on Dec. 21, 2016.

(51) Int. Cl. G06Q 30/02; G06Q 10/06; G06F 17/30

(52) U.S. Cl. CPC G06Q 30/0203; G06F 17/30598; G06Q 10/06393; G06Q 10/06395

(57) ABSTRACT

A system and method of providing electronic patron feedback over a network to at least one organization computing device is provided. The method involves receiving, at a server, at least one electronic patron feedback over the network, the server having a processor and a memory, wherein the processor is configured for: classifying each of the electronic patron feedback as being at least one of a plurality of priorities, the plurality of priorities comprising a first priority and a second priority; transmitting, over the network, the electronic patron feedback classified as being a first priority to the at least one organization computing device in substantially real-time; and transmitting, over the network, the electronic patron feedback classified as being a second priority to the at least one organization computing device at a later time; and receiving, at the at least one organization computing device, the electronic patron feedback.

### RELATED APPLICATIONS

This application claims the benefit of U.S. Provisional Patent Application Ser. No. 62/437,408, filed Dec. 21, 2016, the entire contents of which are hereby incorporated by reference herein for all purposes.

### FIELD

The embodiments described herein relate to the field of patron experience technology, and in particular, to methods and systems for collecting and distributing patron feedback data to organizations, for example from patrons such as customers or employees.

### INTRODUCTION

The following paragraphs are not an admission that anything discussed in them is prior art or part of the knowledge of persons skilled in the art.

Organizations can use feedback from their patrons (such as customers, employees, etc.) to evaluate their performance in providing products and/or services. Such feedback can be important for organizations to identify areas of improvement, develop business intelligence about their patrons, remain competitive, and improve profitability.

For example, traditionally, organizations collected customer feedback via paper surveys available to customers as they depart and deposited in a drop box. More recently, organizations have also included messages on receipts, directing customers to an online survey. These channels may not be convenient for customers, however, and many customers may instead decline to provide feedback.

Customers may also provide feedback about an organization to other customers by providing reviews on a third-party site. In order to access this feedback, organizations may need to proactively monitor such third-party sites, which can be time consuming.

Finally, various channels of obtaining customer feedback may introduce significant delays between the time that a customer provides feedback and the time that the feedback is received in a useful manner by the organization. Such delays can be decrease the usefulness of the feedback to the organization, making it difficult for organizations to be responsive to their customers, particularly in the face of urgent complaints.

### SUMMARY OF SOME EMBODIMENTS

According to some embodiments, there is a method of providing electronic patron feedback over a network to at least one organization computing device. The method comprises receiving, at a server, at least one electronic patron feedback over the network. The server comprises a processor and a memory, wherein the processor is configured for classifying each of the electronic patron feedback as being at least one of a plurality of priorities, the plurality of priorities comprising a first priority and a second priority;, and transmitting, over the network, the electronic patron feedback classified as being a first priority to the at least one organization computing device in substantially real-time. The processor is also configured for transmitting, over the network, the electronic patron feedback classified as being a second priority to the at least one organization computing device, in some cases at a later time. The at least one organization computing device receives the electronic patron feedback. The at least one organization computing device includes a user interface for providing the electronic patron feedback to a user of the at least one organization computing device.

The step of transmitting, over the network, the electronic patron feedback classified as being a first priority to the at least one organization computing device in substantially real-time may further comprise, for each electronic patron feedback classified as being a first priority, transmitting a corrective action recommendation responsive to that electronic patron feedback.

The step of transmitting a corrective action recommendation responsive to that electronic patron feedback may further comprise accessing a database storing a plurality of corrective actions, each of the plurality of corrective actions being related to at least one pre-determined feedback, and identifying a corrective action recommendation from the plurality of corrective actions based on the at least one pre-determined feedback of the corrective action recommendation being similar to that electronic patron feedback classified as being a first priority.

The step of receiving, at a server, at least one electronic patron feedback over the network may further include receiving patron data corresponding to that electronic patron feedback. The processor may be further configured for comparing the patron data to a plurality of verified patron data, and determining whether the electronic patron feedback is valid based on whether the corresponding patron data matches at least one of the plurality of verified patron data.

The method may further comprise, if the electronic patron feedback is valid, storing the electronic patron feedback in a main database.

In some examples, the step of receiving, at a server, at least one electronic patron feedback over the network may include, for each electronic patron feedback: providing a timestamp. This step may include, and determining whether the electronic patron feedback is substantially similar to other electronic patron feedback stored in the staging database.

The step of determining whether the electronic patron feedback is valid based on whether the corresponding patron data matches at least one of the plurality of verified patron data may further comprise determining whether the timestamp of the electronic patron feedback is substantially similar to the timestamp of the other electronic patron feedback. The processor may also determine a tally of the other electronic patron feedback that is substantially similar to the electronic patron feedback and has a substantially similar timestamp, and if the tally exceeds a particular threshold indicative of invalid feedback, then determining that the electronic patron feedback is invalid. Otherwise, a determination may be made that the electronic patron feedback is valid.

In some examples, the step of receiving, at a server, electronic patron feedback over the network may further include other techniques for validating the legitimacy of patron feedback.

In some examples, the electronic patron feedback may comprise free form text, and the step of classifying each of the electronic patron feedback as being at least one of a plurality of priorities may comprise, for each electronic patron feedback: parsing the electronic patron feedback to identify patron keywords, comparing the patron keywords to a set of first priority keywords, and if the patron keywords match the set of first priority keywords, classifying the electronic patron feedback as being the first priority.

The electronic patron feedback may comprise a rating selection from a plurality of rating options, each of the plurality of rating options being classified as one of the plurality of priorities. The step of classifying each of the electronic patron feedback as being at least one of a plurality of priorities may comprise, for each electronic patron feedback: if the rating selection is classified as the first priority, classifying the electronic patron feedback as being the first priority, and if the rating selection is classified as the second priority, classifying the electronic patron feedback as being the second priority.

The at least one electronic patron feedback may comprise a first electronic patron feedback and a second electronic patron feedback, each of the first electronic patron feedback and the second electronic patron feedback being classified as being a first priority. The method may further comprise determining which of the first electronic patron feedback and the second electronic patron feedback to provide to the user with enhanced alerts.

The method may further comprise receiving, at the server, a message responsive to the first electronic patron feedback sent from the at least one organization computing device over the network, transmitting, over the network, the message to a first patron computing device, and receiving, at the first patron computing device, the message sent from over the network, the first patron computing device comprising a user interface for providing the message to the first patron.

According to another aspect, there is a system for providing electronic patron feedback over a network to at least one organization computing device. The system comprises a processor and a memory, wherein the processor is configured for receiving the electronic patron feedback over the network, the electronic patron feedback comprising at least one electronic patron feedback, classifying each of the electronic patron feedback as being at least one of a plurality of priorities, the plurality of priorities comprising a first priority and a second priority, transmitting, over the network, the electronic patron feedback classified as being a first priority to the at least one organization computing device in substantially real-time. The processor may also be configured for transmitting. The at least one organization computing device may include a user interface for providing the electronic patron feedback to a user of the at least one organization computing device.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is a block diagram of a system for providing electronic patron feedback over a network to at least one organization computing device, according to one embodiment;

FIG. 1B is a block diagram of a system for providing electronic patron feedback over a network to at least one organization computing device, according to another embodiment;

FIG. 2 is an illustration of an example screenshot of a home screen of an organization feedback application, according to one embodiment;

FIG. 2A is an illustration of another example screenshot of a home screen of an organization feedback application, according to one embodiment;

FIGS. 3A and 3B are a top portion and a bottom portion of an illustration of an example screenshot of a dashboard and reports screen of an organization feedback application, according to one embodiment;

FIGS. 3C and 3D are illustrations of another example screenshot of a dashboard and reports screen;

FIG. 4 is an illustration of another example screenshot of a dashboard and reports screen of an organization feedback application, according to one embodiment;

FIG. 4A is an illustration of another example screenshot of a dashboard and reports screen;

FIG. 5 is an illustration of an example screenshot of an alert screen of an organization feedback application, according to one embodiment;

FIG. 5A is an illustration of another example screenshot of an alert screen of an organization feedback application;

FIG. 5B is an illustration of another example screenshot of an alert screen of an organization feedback application;

FIG. 6 is an illustration of another example screenshot of an alert screen of an organization feedback application, according to one embodiment;

FIG. 6A is an illustration of another example screenshot of an alert screen of an organization feedback application;

FIG. 6B is an illustration of yet another example screenshot of an alert screen of an organization feedback application;

FIG. 7 is an illustration of an example screenshot of an advice screen of an organization feedback application, according to one embodiment;

FIG. 7A is an illustration of an example screenshot of an advice screen of an organization feedback application;

FIG. 8 is an illustration of an example screenshot of a learn & grow screen of an organization feedback application, according to one embodiment;

FIG. 8A is an illustration of an example screenshot of a learn & grow screen of an organization feedback application;

FIG. 9 is an illustration of another example screenshot of a learn & grow screen of an organization feedback application, according to one embodiment;

FIG. 9A is an illustration of another example screenshot of a learn & grow screen of an organization feedback application; and

FIG. 10 is a flowchart diagram illustrating the steps of providing electronic patron feedback to an organization computing device, according to one embodiment.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

The terms “an embodiment,” “embodiment,” “embodiments,” “the embodiment,” “the embodiments,” “one or more embodiments,” “some embodiments,” and “one embodiment” mean “one or more (but not all) embodiments of the subject matter described in accordance with the teachings herein,” unless expressly specified otherwise.

The terms “including,” “comprising” and variations thereof mean “including but not limited to”, unless expressly specified otherwise. A listing of items does not imply that any or all of the items are mutually exclusive, unless expressly specified otherwise. In addition, the terms “a,” “an” and “the” mean “one or more,” unless expressly specified otherwise.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical element or electrical signal (either wired or wireless) or a mechanical element depending on the particular context.

Further, although processes, methods, and the like may be described (in the disclosure and/or in the claims) having acts in a certain order, such processes and methods may be configured to work in alternate orders while still having utility. In other words, any sequence or order of actions that may be described does not necessarily indicate a requirement that the acts be performed in that order. The acts of processes and methods described herein may be performed in any order that is practical and has utility. Further, some actions may be performed simultaneously, if possible, while others may be optional, if possible.

When a single device or article is described herein, it may be possible that more than one device/article (whether or not they cooperate) may be used in place of a single device/article. Similarly, where more than one device or article is described herein (whether or not they cooperate), it may be possible that a single device/article may be used in place of the more than one device or article.

The term “organization”, as used herein, broadly refers to an entity that offers products and/or services. The organization might for example be a retail, commercial, or industrial business, a company, a division within a company, firm, charity, a hospital or other medical facility, a government institution, and so on. Furthermore, the organization can be a single individual or a plurality of individuals.

The term “patron”, as used herein, broadly refers to a person who interacts with an organization, such as a customer, employee, client, guest, user, or consumer of products and/or services offered by the organization. In some examples, a patron is human being that provides feedback (i.e., their opinion) about a service or a product that they have received from an organization. In one specific example, the patron could be an employee or other user of a system providing feedback to an information technology (i.e. IT) system to troubleshoot a technical issue with a product or service.

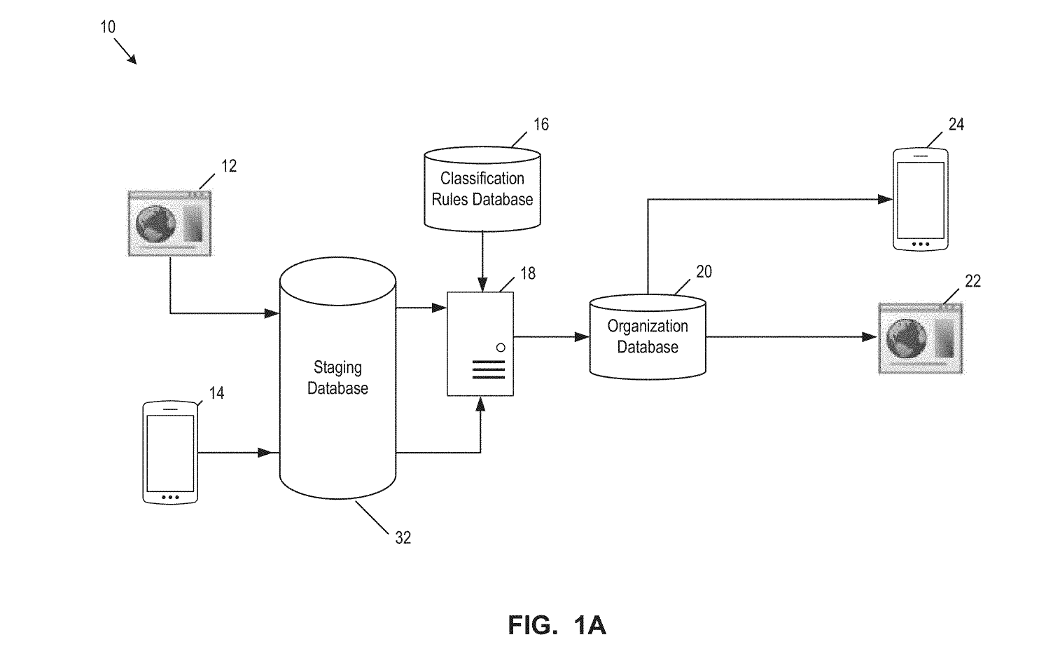

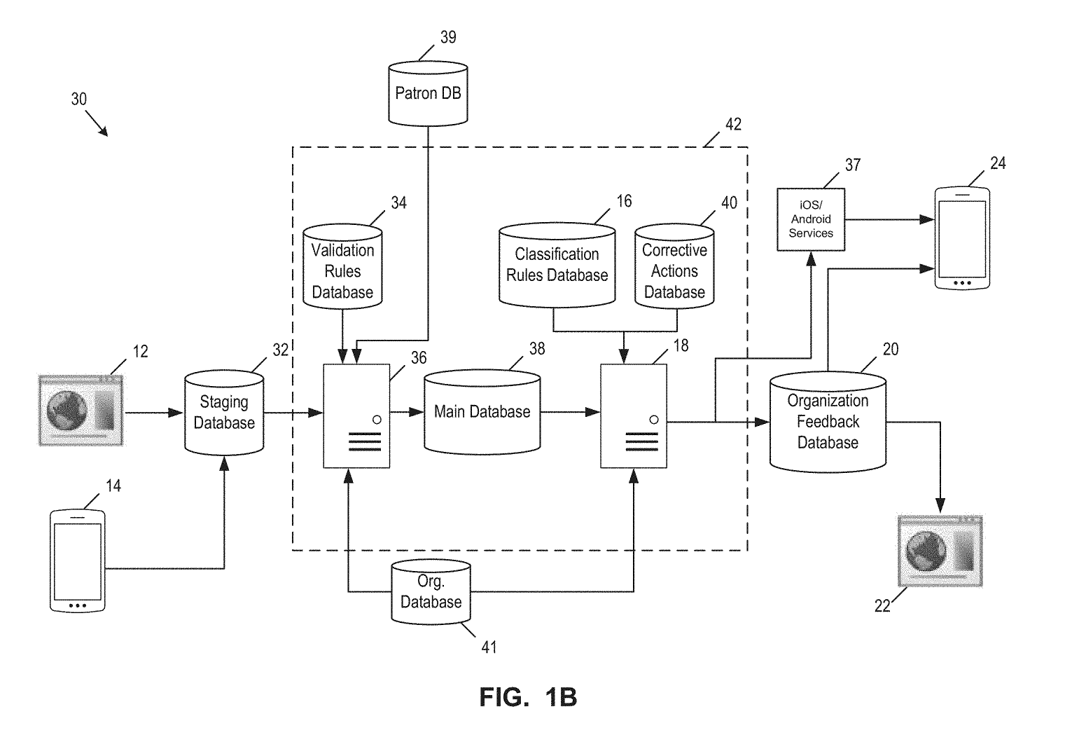

Referring now to FIG. 1A, illustrated therein is a system 10 for providing electronic patron feedback over a network to at least one organization computing device, according to at least one embodiment.

The system 10 generally includes a processor 18 coupled to databases 16 and 20. In various embodiments, the processor 18 includes a network interface (not shown) for connecting to a network.

The system 10 can include one or more patron computing devices 14 and organization computing devices 24, each including a network interface (not shown) for connecting to the network. The patron computing devices 14 and organization computing devices 24 can be configured to communicate with the processor 18 (in some instances through a staging database 32 for security purposes as discussed in more detail below). The patron computing devices 14 and organization computing devices 24 might be any suitable computing device, such as a desktop computer, a portable laptop computer, or a mobile device such as a smartphone or a tablet computer. In some embodiments, the organization computing device 24 is a mobile device that can be carried by a user, such as a smartphone or tablet.

The processor 18 can be any computing device suitable to communicate with one or more patron computing devices 14 and one or more organization computing devices 24. The processor 18 is generally located remotely from the patron computing devices 14 and organization computing devices 24, although in some embodiments the processor 18 may be provided on or in association with an organization computing device 24.

Moreover, although described as a single processor, in some embodiments, the processor 18 can be distributed such that functionality of the processor 18 resides on separate computing devices.

In some specific embodiments, the processor 18 can be a server capable of providing a web server application 12 that is accessible by a web browser application (or other interface) on a patron computing device 14 or another computing device. For example, the server can provide a web service that is accessible by a standalone application on the patron computing device 14. Generally, the application 12 may be an API allows another system (i.e., a third party system) to process a batch of feedback messages and send those messages through the system 10 for processing.

Web service application 22 is an API that others (i.e., third parties) may use if they want to access the data (i.e., alerts, metrics, advice, etc.), particularly for integration with their own customer management systems.

In some embodiments, the processor 18 may communicate with the computing device 24 via one or more services, such as Apple iOS and/or Android services. For instance, in one exemplary embodiment, first priority feedback can be communicated in substantially-real time directly to the computing device 24 via Apple or Android services, while second priority feedback can be sent to the database 20 and be accessed by the computing device 24 at an appropriate time (such as when the application is active on the computing device 24).

The term “patron feedback application”, as used herein, broadly refers to a web server application 12 or a standalone application accessible by the patron computing device.

The term “organization feedback application” as used herein, broadly refers to a web server application 12 or a standalone application accessible by the organization computing device 24.

In some embodiments, the patron feedback application and the organization feedback application are the same application. That is, a single application can have a plurality of functions that might be used as the patron feedback application and as the organization feedback application.

In general the processor 18 can receive electronic patron feedback from the patron computing device 14. The processor 18 can analyze the electronic patron feedback. The processor 18 can also transmit electronic patron feedback to the organization computing device 24.

The processor 18 is generally coupled to a classification rules database 16 and an organization feedback database 20. Although shown as separate databases, in some embodiments, the classification rules database 16 and the organization feedback database 20 might in some embodiments reside on a single memory device. Furthermore, although a single database is shown for each database 16, 20, in some embodiments, each database can be distributed such that the databases 16, 20 reside on a plurality of memory devices.

The processor 18 is operable analyze the electronic patron feedback based on rules stored in the classification rules database 16. The classification rules database 16 can store rules for classifying electronic patron feedback as at least one of a plurality of priorities. The classification rules can be pre-determined by a management body of the organization.

In some embodiments, the electronic patron feedback can include free form text, and the classification rules database can include a set of keywords for each priority. In some examples, the processor 18 can parse the electronic patron feedback to identify keywords of the electronic patron feedback. The processor 18 can compare the parsed keywords to each set of keywords, and can determine the set of keywords that the parsed keywords are most similar to. This allows the electronic patron feedback to be classified according to the priority of the set of keywords that the parsed keywords are most similar to.

In some embodiments, the electronic patron feedback can include one or more rating selection from a plurality of rating options. The plurality of rating options can each be classified as one of the plurality of priorities. In some cases, the processor 18 can classify the electronic patron feedback as the same priority as that of the rating option.

The plurality of priorities can relate to whether or not the electronic patron feedback requires immediate attention, that is, real time or substantially real-time attention by the organization. For example, electronic patron feedback for a restaurant might indicate that wait times are too long and hence turning customers away, or that the food quality is suffering on weekdays. Such electronic patron feedback could be categorized as having a priority that requires immediate attention.

Alternatively, electronic patron feedback can indicate that customers enjoyed their meals and were pleased with the service. Such electronic patron feedback can be categorized as not requiring immediate attention, but rather can categorized as having a priority that can receive attention at a later time (i.e., a non-immediate time period).

The organization feedback database 20 can store electronic patron feedback received from the patron computing devices 14. In some embodiments, when electronic patron feedback not transmitted to organization computing devices 24 in substantially real-time, the electronic patron feedback can be initially stored in the organization feedback database 20 and subsequently retrieved from the organization feedback database 20 for transmission. In some embodiments, electronic patron feedback, whether or not it is transmitted in substantially real-time or later, can be stored in the organization feedback database 20.

Referring now to FIG. 1B, illustrated therein is a system 30 for providing electronic patron feedback over a network to at least one organization computing device, according to at least another embodiment. Similar to system 10, system 30 includes a processor 18 and memory 16 and 20. System 30 also includes processor 36 and the staging database 32, validation rules database 34, main feedback database 38, and a corrective actions database 40. Furthermore, system 30 includes a secure zone 42, which can encompass processors 18 and 36, the validation rules database 34, the main feedback database 38, the classification rules database 16, and the corrective actions database 40.

When electronic patron feedback is initially received by system 30, the electronic patron feedback can be stored in staging database 32. Processor 36 can be coupled to staging database 32 and retrieve electronic patron feedback from staging database 32. In some other embodiments, processor 36 can receive electronic patron feedback directly from the patron computing device 14.

Similar to processor 18, processor 36 can be any computing device suitable to communicate with patron computing devices 14 (and in some cases may be the same processor 18). Processor 36 is generally located remotely from each of the patron computing devices 14. As well, although described as a single processor, in some embodiments, processor 36 can be distributed such that the functionality of processor 36 resides on separate computing devices (i.e., a plurality of processors).

Processor 36 can also be coupled to the validation rules database 34 and the main feedback database 38. The validation rules database 16 can store rules for determining whether electronic patron feedback is valid. Valid electronic patron feedback generally relates to desirable feedback that is submitted to the system 30 by patrons of the organization. Invalid feedback generally relates to unwanted feedback, for example feedback that is submitted to the system 30 by any other third-party, including robots (i.e. due to a denial of service attack, or spam or “fake” feedback).

Processor 36 can analyze the electronic patron feedback based on rules stored in the validation rules database 34. Processor 36 and the validation rules database 34 can generally serve as a filter to maintain integrity of the electronic patron feedback. In some cases, the processor 36 can use rules stored in the validation rules database 34 to determine whether the electronic patron feedback is valid.

For example, robots may attempt to submit a large volume of identical, or at least similar, feedback within a short period of time. A large volume of identical, or at least similar, feedback can be in the order of hundreds if not thousands of feedback messages. In some cases, the short period of time can be in the order of seconds.

In some specific examples, when electronic patron feedback is first received by the staging database 32, the electronic patron feedback may receive a timestamp indicating the time at which the electronic patron feedback was received. Processor 36 can analyze other electronic patron feedback stored in the staging database 32 to determine whether the current electronic patron feedback is identical to, or at least similar to, other electronic patron feedback stored in the staging database, and received at relatively the same time (i.e., the timestamps are similar). If so, the electronic patron feedback may be flagged as being invalid, and can be diverted away from the main feedback database 38 in the secure zone 42.

It will be understood that various other techniques for validating the legitimacy of patron feedback may be used by the processor 36.

In some embodiments, to determine whether electronic patron feedback is valid, the rules can be directed to the receipt of some particular number of similar electronic feedback messages, such as 100 or 1000 similar electronic patron feedback. In some embodiments, the rules can be directed to the receipt of 2000 similar electronic patron feedback. In some embodiments, to determine whether electronic patron feedback is valid, the rules can be directed to the receipt of some particular number of similar electronic patron feedback within some particular period of time, such was within sixty (60) seconds, or ten (10) seconds. In some embodiments, the rules can be directed to the receipt of similar electronic patron feedback within five (5) seconds.

Invalid feedback can also relate to feedback that is submitted to the system 30 by any another third-party who is not a patron of the organization. In some embodiments, the system can include a patron database 39. The patron database 39 can store patron identifying information about verified patrons. When electronic patron feedback is first received by the staging database 32, the electronic patron feedback may be stored with patron identifying information received from the patron feedback application. Processor 36 can compare the patron identifying information for the current electronic patron feedback to determine whether it matches patron identifying information stored in the patron database 39. If so, the electronic patron feedback can be validated. In some cases, if no match is found the electronic patron feedback may be flagged as invalid, and/or subjected to a more detailed analysis (i.e., based on other rules such as timestamps, etc.)

If the electronic patron feedback is valid, processor 36 can store the electronic patron feedback in the main feedback database 38. In various examples, the main feedback database 38 can store electronic patron feedback for a plurality of organizations or for a single organization. Once electronic patron feedback is stored in the main feedback database 38, it can be retrieved by processor 18.

In some embodiments, processor 36 may continue to analyze the electronic patron feedback stored in the main feedback database 38 using rules stored in the validation rules database 34. Processor 36 can identify and remove invalid feedback that was initially identified as being valid.

Similar to system 10, the electronic patron feedback in system 30 can be analyzed by processor 18 using the classification rules database 16 and stored in the organization feedback database 20.

Processor 18 can also be coupled to a corrective actions database 40. The corrective actions database 40 can store a plurality of actions that can be taken by the organization. Each of the plurality of actions may be linked to at least one pre-determined feedback. The actions stored in the corrective actions database 40 can be derived from statistical data that indicates a correlation between an action taken for a pre-determined feedback and improved satisfaction after the action was taken.

After classifying electronic patron feedback, the processor 18 can identify a corrective action for the electronic patron feedback using the corrective actions database 40. The processor 18 can use the classification rules database 16 to identify a pre-determined feedback that is correlated to the electronic patron feedback. Having identified a pre-determined feedback, the processor 18 can identify one or more corrective actions in the corrective actions database 40 that are linked to the pre-determined feedback and select an appropriate corrective action for the electronic patron feedback.

Although a single database is shown for each of the databases 20, 34, 16, 39, and 40, in some embodiments, each database can be distributed such that the database resides on a plurality of memory devices.

In some embodiments, the patron database 39 can also be used to generate market data about patrons. For instance, in one example one or both of the processor 18 and the processor 36 can access the patron database 39 to generate advice and insights.

In some embodiments, system 30 can also include an organization database 41. The organization database 41 can store profile information about organizations, including financial and business data about the organization and its competitors. Financial and business data can include, but is not limited to, the size of the organization, the number of employees, and financial metrics such as annual revenue, profit, earnings before interest, taxes, depreciation, and amortization (EBITDA), and stock price. In some embodiments, the processor 18 may access the organization database 41 to generate advice and insights. In some embodiments, the processor 36 may access the organization database 41 to validate actual membership of a particular patron or customer.

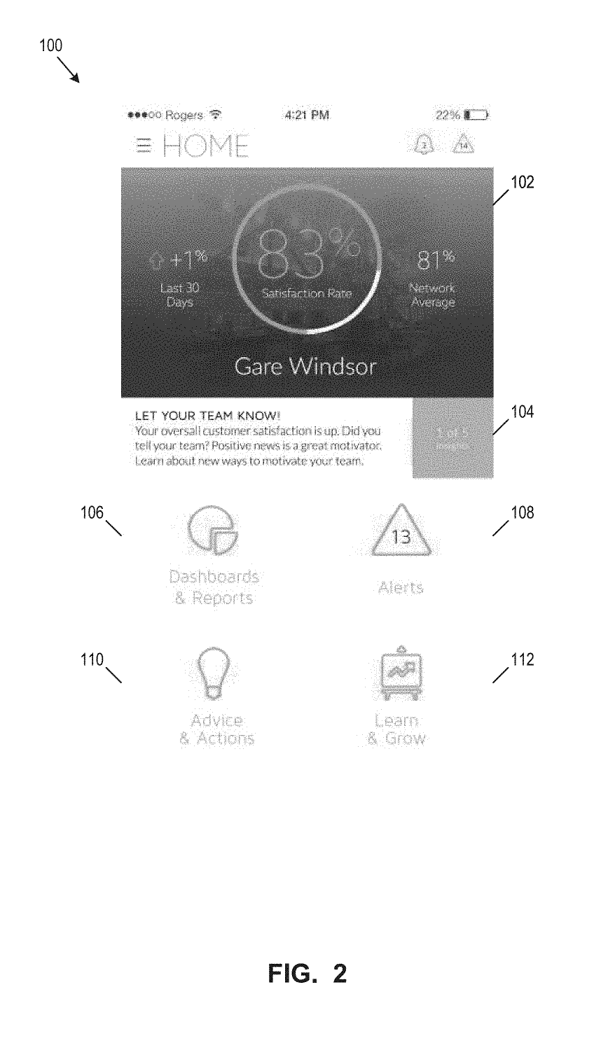

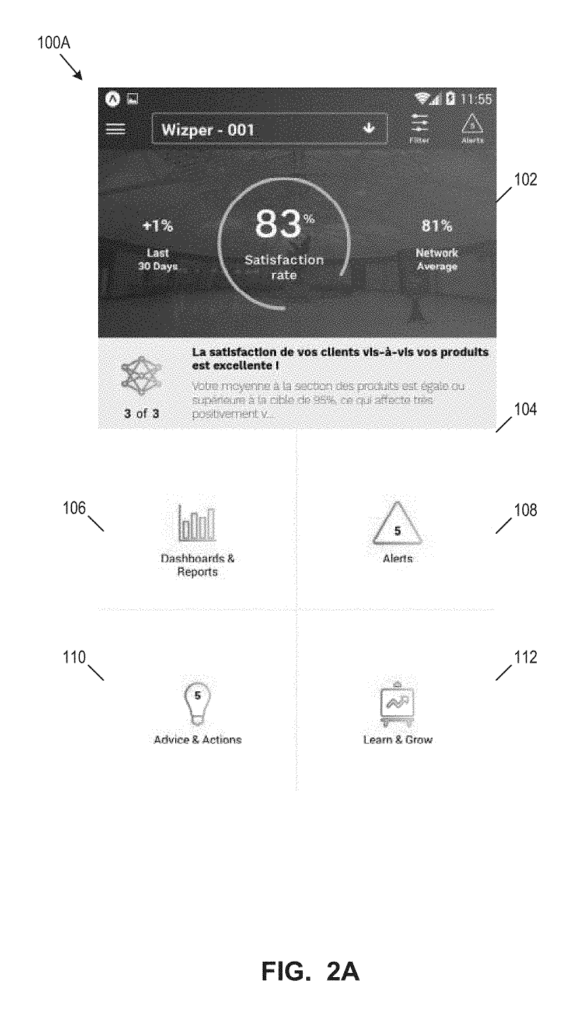

Referring now to FIGS. 2 to 9, illustrated therein are example screenshots of various screens of an organization feedback application, according to at least one embodiment.

FIG. 2 shows a home screen 100. The home screen can include various metrics 102 including, for example, an indication of the overall satisfaction rate of patrons to the organization, or a “customer experience score”. The overall satisfaction rate of patrons to other similar organizations and/or the rate of change of the overall satisfaction of patrons to the organization can also be provided. The overall satisfaction rate of patrons to the organization can be determined by processor 18 based on electronic patron feedback. The processor 18 can use rules for example in the classification rules database 16 to determine a level of satisfaction for each electronic patron feedback. The overall satisfaction rate can be updated on a substantially real-time basis as the electronic patron feedback is received.

The home screen 100 can also include insights 104 based on the metrics. Insights 104 can include, for instance, a reminder to let members, or staff, of the organization know about the overall satisfaction rate. Insights can be determined by processor 18. The processor 18 can identify one or more insights based on the various metrics, including for example, the overall satisfaction rate. In some embodiments, a plurality of insights can be stored in the corrective actions database 40 and each insight can be stored in linked relation to overall satisfaction rates. The processor 18 can use the corrective actions database 40 to identify insights based the overall satisfaction rate.

The home screen 100 can also include navigation buttons to access additional screens. For example, the home screen 100 can include a navigation button to access dashboards and reports 106, alerts 108, advice and actions 110, and training (e.g., “learn & grow”) 112.

FIG. 2A shows another embodiment of a home screen 100A.

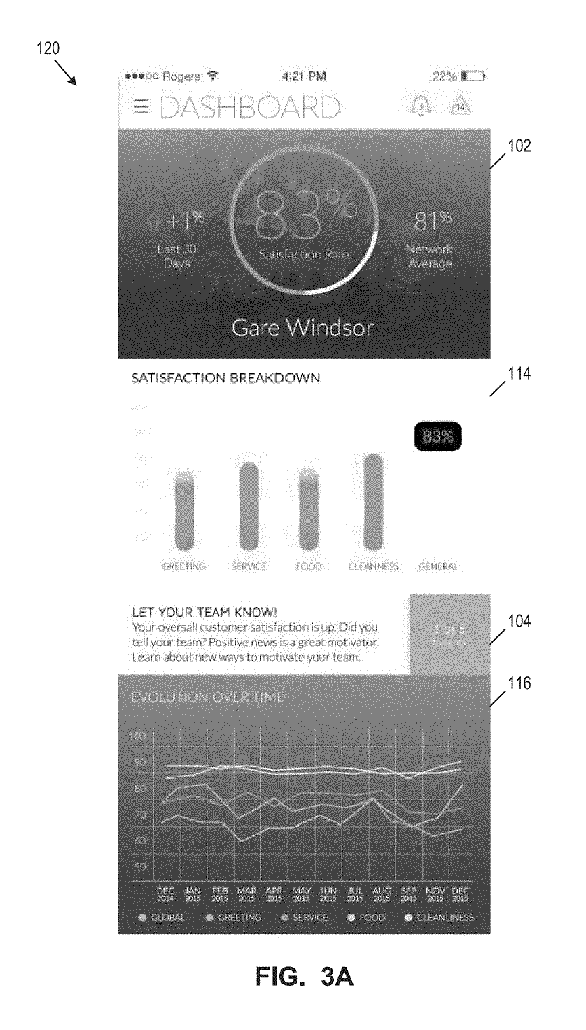

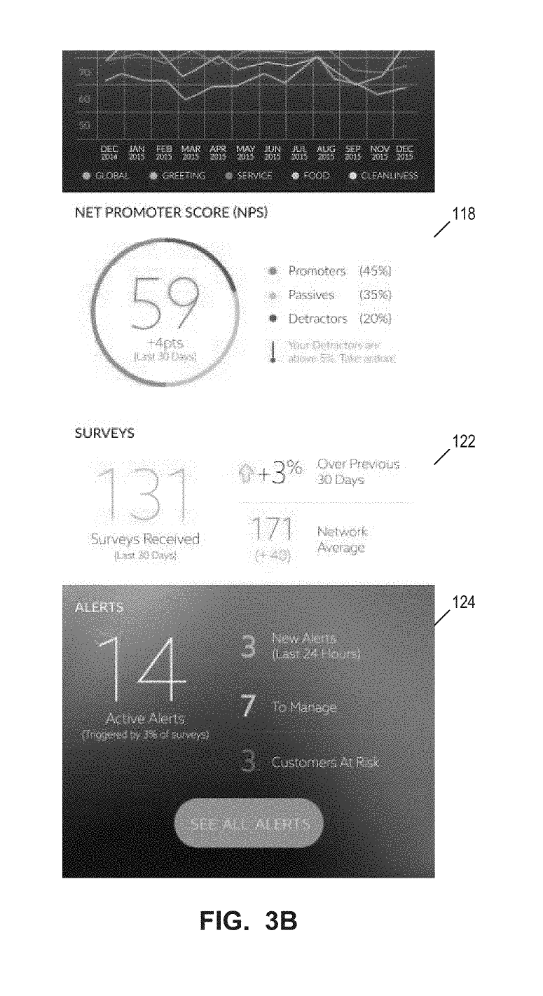

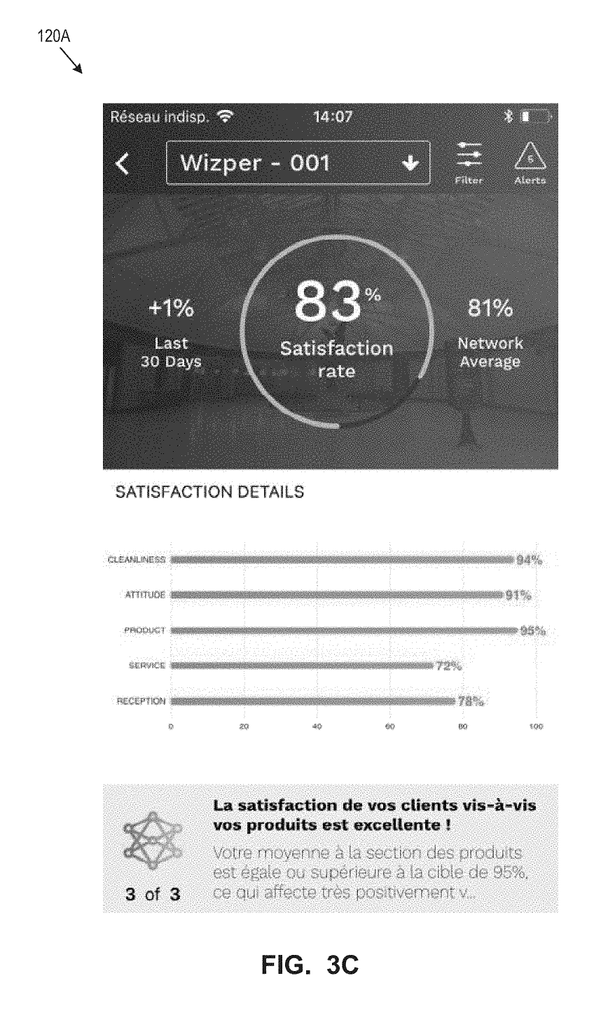

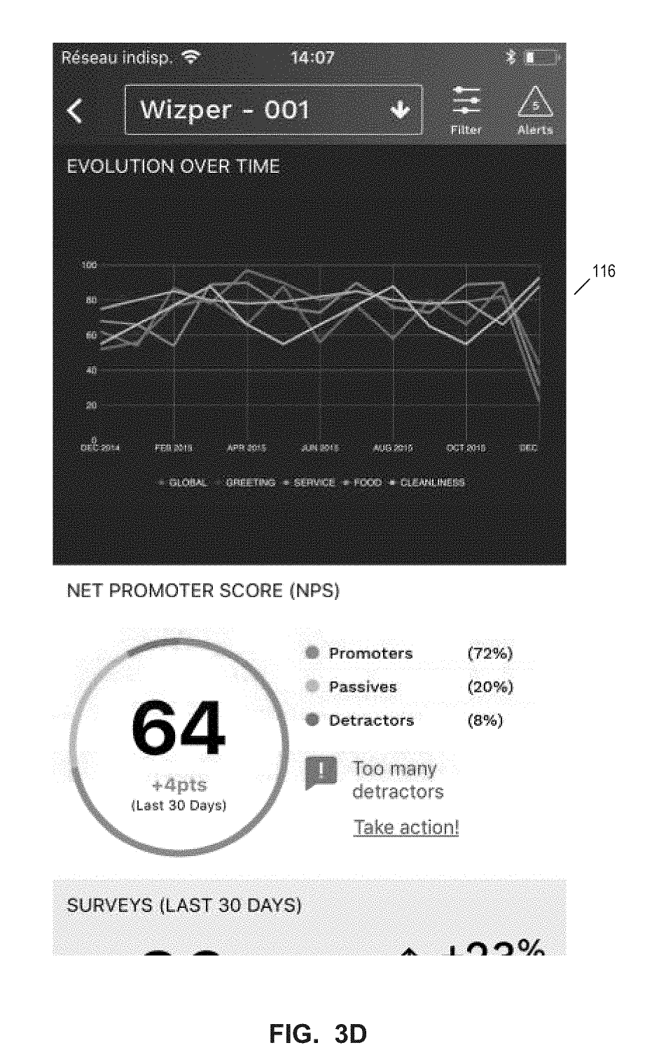

FIG. 3A and 3B show a dashboard and reports screen 120. Similar to the home screen 100, the dashboard and reports screen 120 can include various metrics 102 and insights 104. Additional details about the metrics can be provided in the dashboard and reports screen 120. For example, the satisfaction rate for various categories 114 such as greeting, service, food, cleanness, and general can be provided. In another example, an illustration of the satisfaction rate over a period of time 116 can be provided. In some embodiments, the dashboard and reports screen can provide all metrics, or indicators, in a single location, or screen.

The satisfaction rate for various categories 114 and the satisfaction rate over a period of time 116 can be determined by processor 18 based on electronic patron feedback. The processor 18 can use rules in the classification rules database 16, for example, to determine a level of satisfaction in each category for each electronic patron feedback. As well, the processor 18 can access past electronic patron feedback from the main feedback database 38 to determine the satisfaction rate over a period of time. The satisfaction rate for each category and the satisfaction rate over a period of time 116 can be updated on a substantially real-time basis as the electronic patron feedback is received.

The dashboard and reports screen 120 can also provide information about patrons that submit feedback about the organization 118. The processor 18 can use rules in the classification rules database 16 to such information about patrons that submit feedback about the organization 118. For example, patrons that submit feedback about the organization can be classified as being one of a plurality of categories, such as promoter, passive, or detractor.

The term “promoter”, as used herein, broadly refers to a patron that submits feedback that enhances, or improves the reputation of the organization.

The term “detractor”, as used herein, broadly refers to a patron that submits feedback that reduces, or diminishes the reputation of the organization.

A passive patron submits feedback that neither enhances or reduces the reputation of the organization.

The dashboard and reports screen 120 can also provide information about the submission of feedback about the organization 122. Information about the submission of feedback about the organization 122 can relate to the number of surveys received, the rate of receipt of surveys, and the number of surveys received by other similar organizations. The processor 18 can access past electronic patron feedback from the main feedback database 38 and/or the organization feedback database 20 to analyse the submission of feedback about the organization.

The dashboard and reports screen 120 can also provide a summary of alerts for the organization 124. Alerts can relate to electronic patron feedback. The processor 18 can keep track of which alerts have or have not been reviewed yet. The number of alerts that have not been reviewed yet can be displayed. The processor 18 can use rules in the classification rules database 18 to analyze electronic patron feedback to determine whether the satisfaction level of patrons has risen to a level at which the patron may pre-maturely terminate their business or interaction with the organization. As shown in FIG. 3B, the summary of alerts can also include a navigation button to access the alerts.

In some embodiments, when a patron fills out a feedback survey, a determination will be made as to whether they are satisfied. If the patron is unsatisfied, this may automatically present an option to the patron to make their contact information (i.e., phone number, email address) available to a user at the organization in real-time or substantially real time to receive a prompt response from that user—a so called “active alert”. If the patron declines this option, then their feedback may be provided as an anonymous or otherwise generic feedback message, without prompting an immediate reply.

FIGS. 3C and 3D show another example of a dashboard and reports screen 120A.

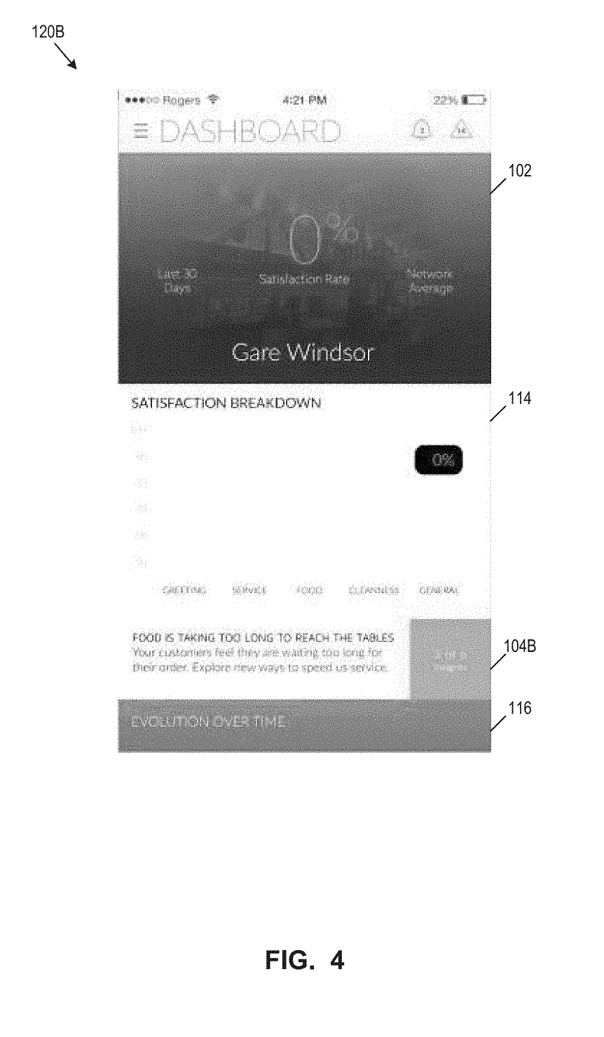

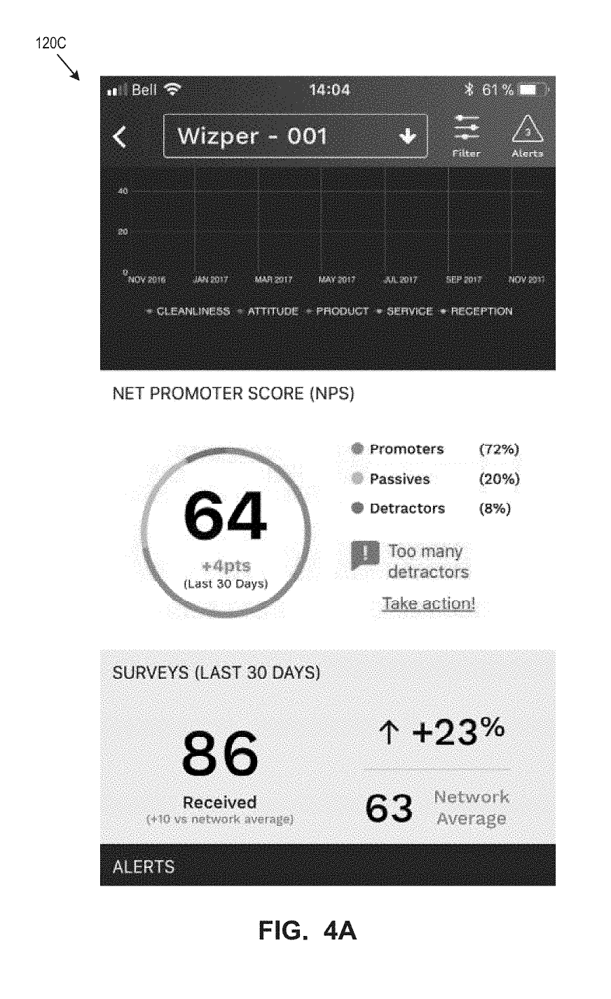

FIG. 4 shows another dashboard and reports screen 120B. Similar to dashboard and reports screen 120, dashboard and reports screen 120B can include various metrics 102, the satisfaction rate for various categories 114, insights 104, and an illustration of the satisfaction rate over a period of time 116. FIG. 4 shows another example insight 104B, namely that food is taking too long to reach tables.

FIG. 4A shows another dashboard and reports screen 120C.

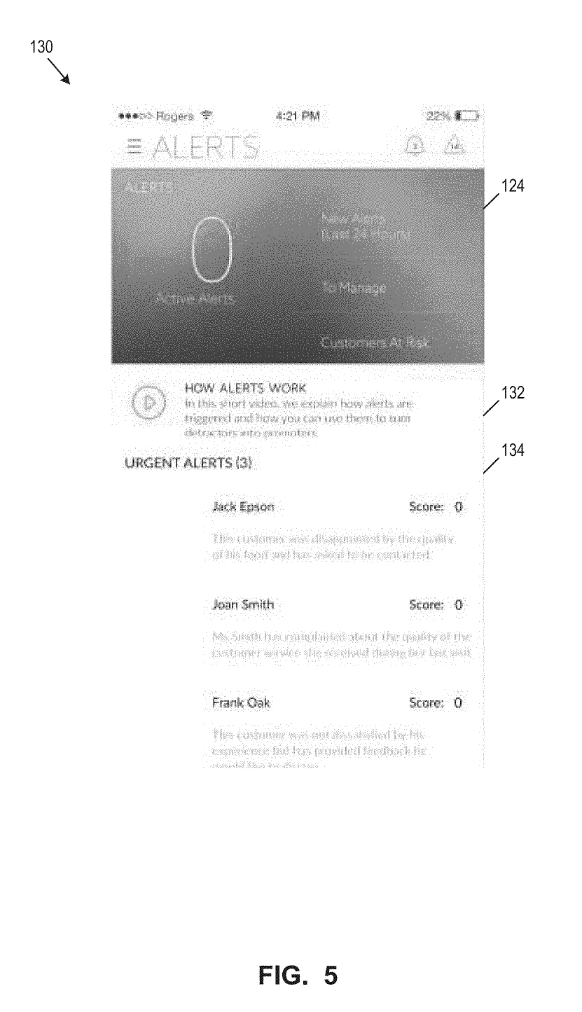

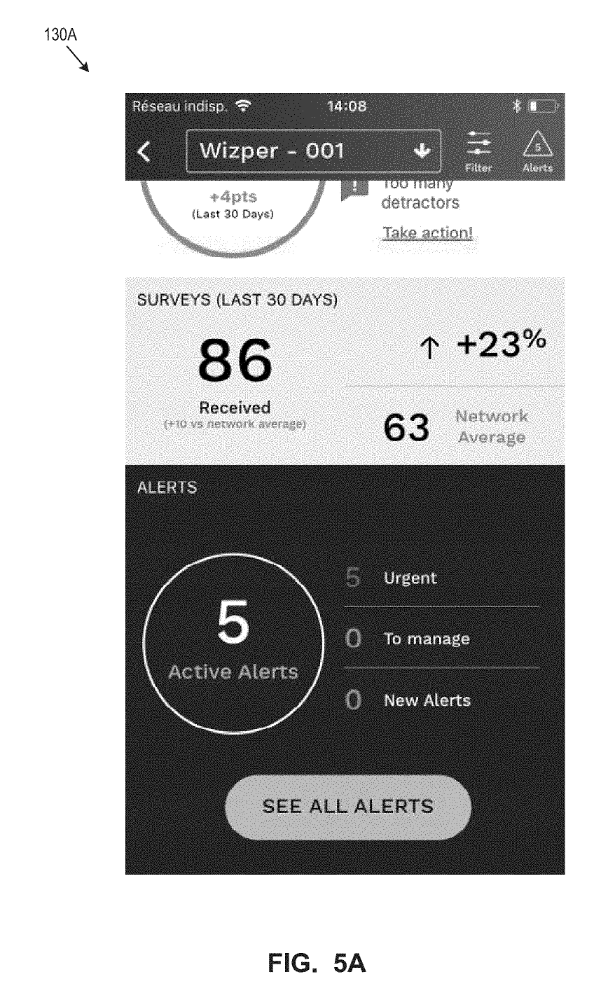

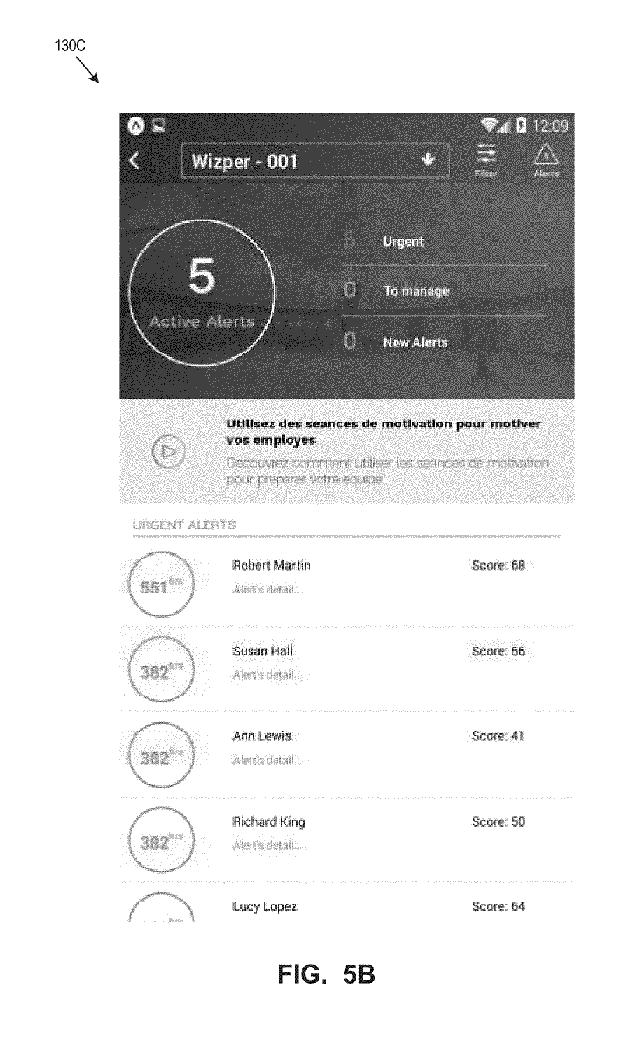

FIG. 5 shows an alerts screen 130, which in some examples can be accessed by pressing the alerts 108 button shown in FIG. 2. Similar to the dashboard & reports screen, alerts screen 130 can provide a summary of alerts for the organization 124, such as the number of new alerts within a particular time period (i.e. the last 24 hours), the number of alerts yet to be managed, the number of customers at risk, and the number of active alerts. The alerts screen 130 can also include a link to information about alerts 132. The alerts screen 130 can display the alerts 134. The alerts can be displayed based on a classification priority, for example, urgent priority (as shown in FIG. 5). The classification priority can be determined by the processor 18 using the classification rules database 16. In some cases, the classification priority could be based on a netpromoter score (i.e., from 0-10), or based on some other algorithm, such as intensity of emotion, etc.

FIG. 5A shows another example of an alerts screen 130A, while FIG. 5B shows another example of an alerts screen 130C.

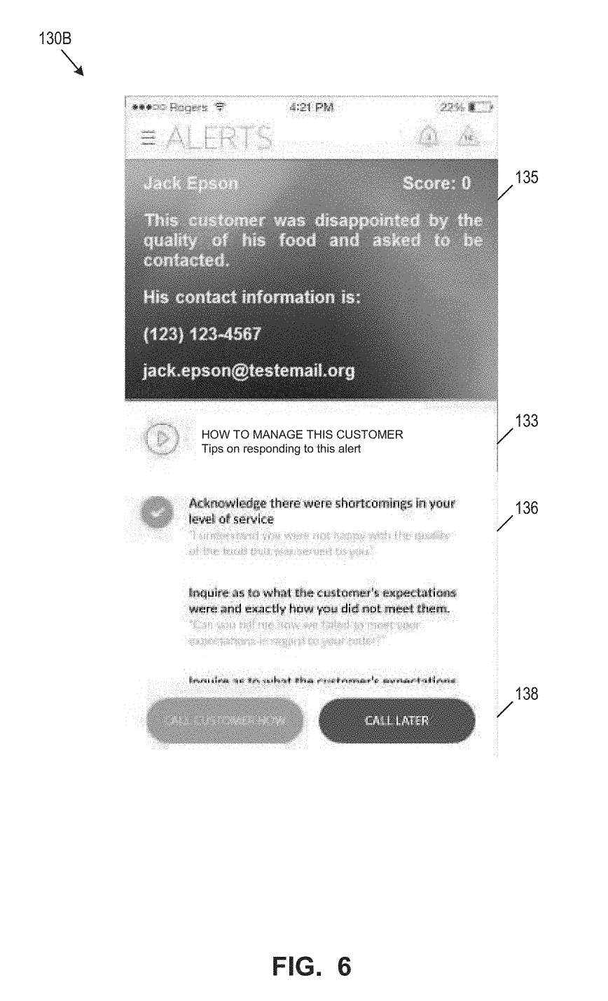

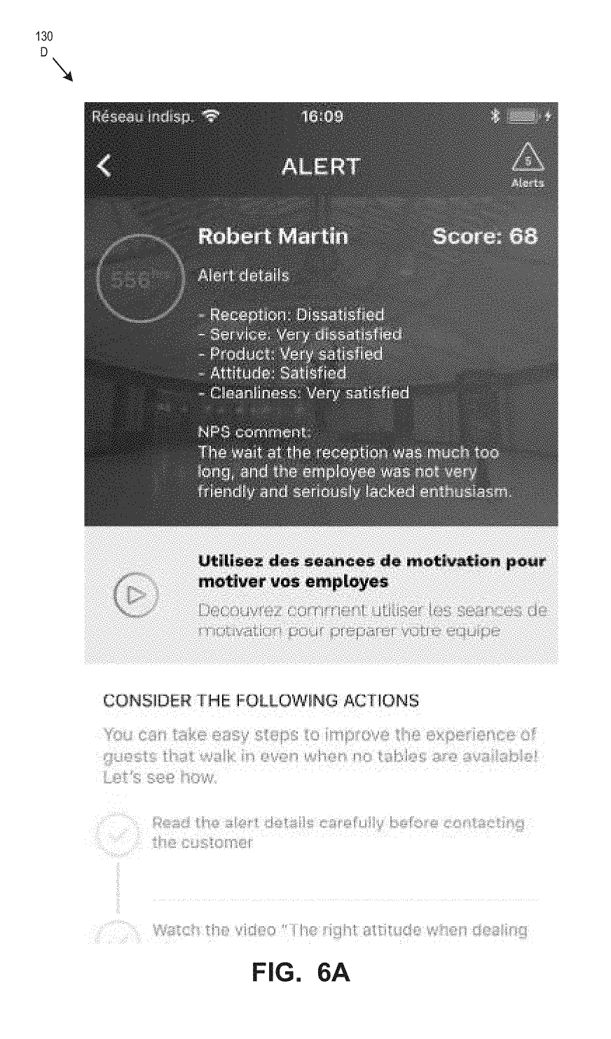

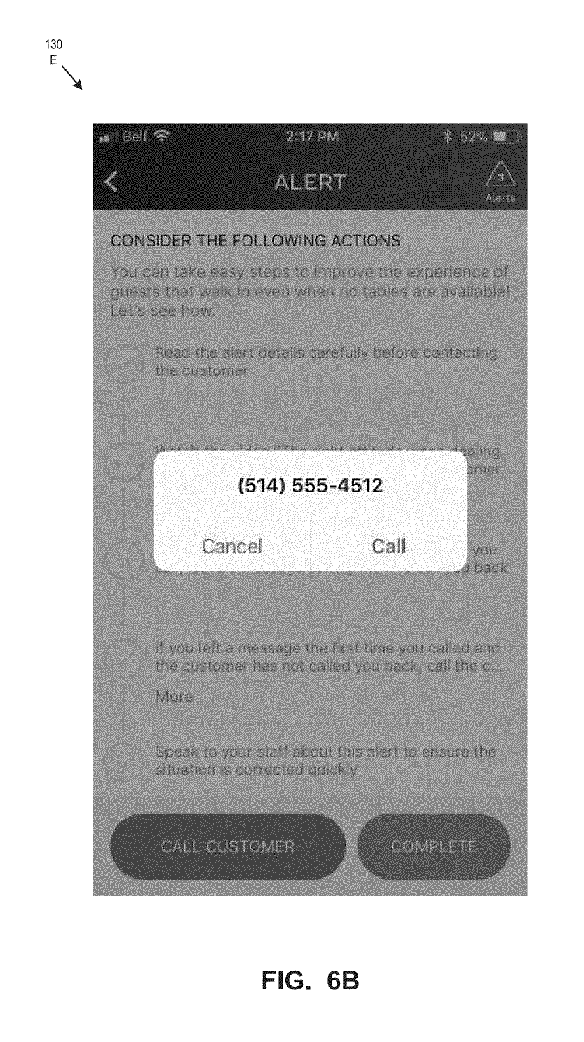

FIG. 6 shows another alerts screen 130B. The alerts screen 130B may appear after a user has reviewed the alerts displayed in screen 130 and has selected a particular alert from the alerts 134 to address. For example, here the user has selected the alert 135 for “Jack Epson”, which might include information about the patron's feedback as well as contact information such as a phone number or email address.

The alert screen 130B may also include training link 133 (i.e., to multimedia such as video, text, etc.) with tips on how to respond to this alert, to allow the user to “learn and grow” and be better prepared for the customer interaction. These tips may be customized for the particular nature of the customer based on their particular complaint, and other information as may be determined by the classification rules database.

The alert screen 130B can display corrective actions 136 that are responsive to the reviewed alerts. For example, as shown in FIG. 5, corrective actions 136 can include acknowledging shortcoming in the level of service and inquiring about that patron's expectations. As set out above, the processor 18 can identify a corrective action for the electronic patron feedback using the corrective actions database 40. In some embodiments, once the user has completed the corrective action 136, a check mark or other button can be activated.

In some embodiments, the alert screen 130B of the organization feedback application can provide options 138 to contact the patron who submitted that electronic patron feedback. The options 138 to contact the patron can include calling the patron or messaging the patron. In some embodiments, the channels to contact the patron can be via the patron feedback application (e.g., instant messaging or calls within the patron feedback application). In some embodiments, the channels to contact the patron can be outside of the patron feedback application (e.g., short message service messaging or voice calls via a cellular network).

FIG. 6A shows another alerts screen 130D, while FIG. 6B shows yet another alerts screen 130E.

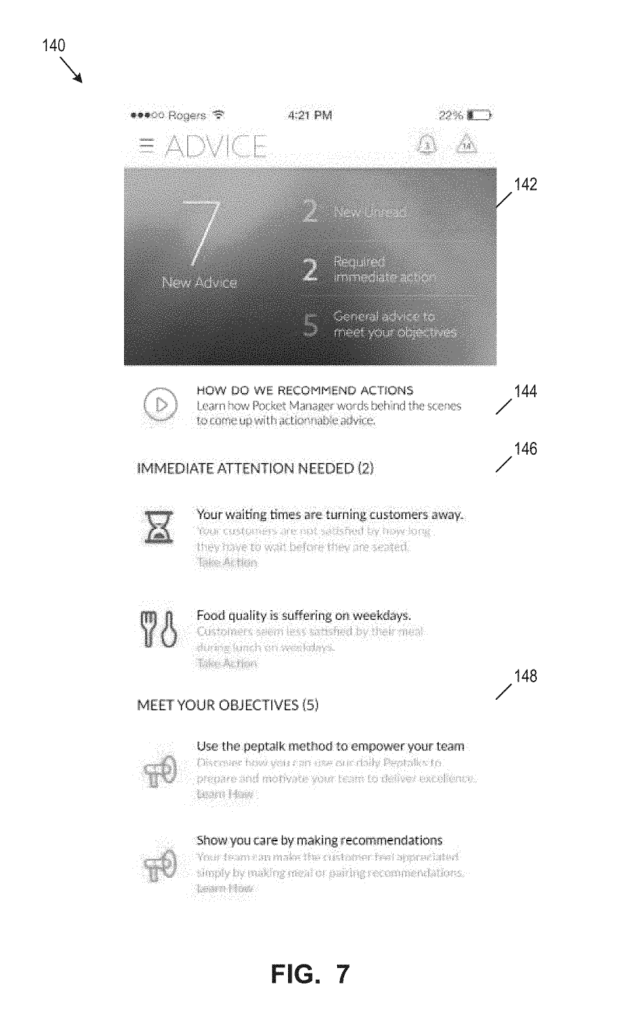

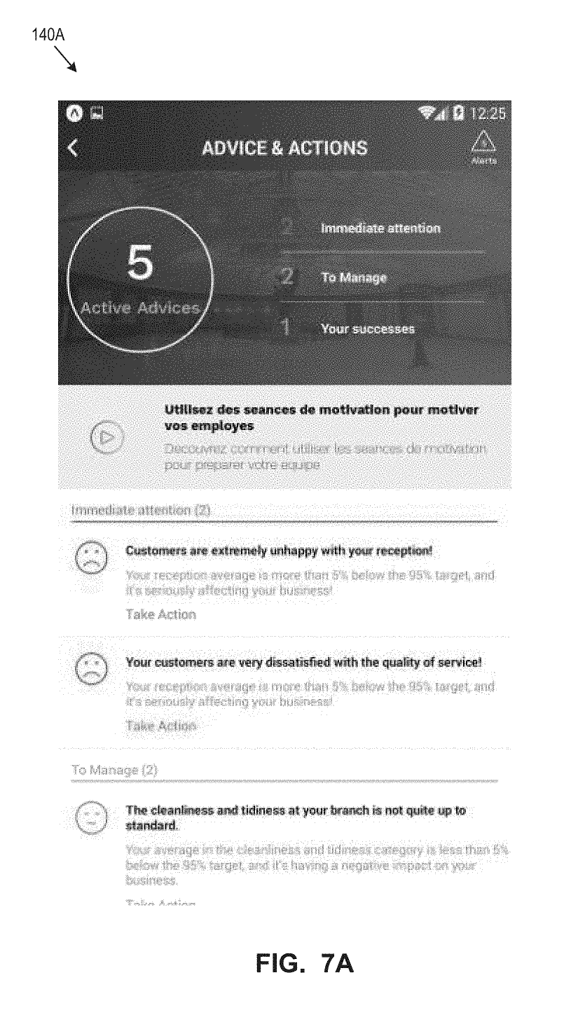

FIG. 7 shows an advice screen 140. The advice screen 140 can include a summary of advice for the organization 142. Advice can be determined based on the electronic patron feedback. The processor 18 can use rules in the classification rules database 18 to analyze electronic patron feedback to identify advice. In some embodiments, advice can also be based on pre-determined objectives for the organization. The pre-determined objectives can be provided by the organization, such as the management body of the organization.

The processor 18 can keep track of which advice have (or have not) yet been reviewed. The number of advice that have not yet been reviewed can be displayed. In some embodiments, advice can also be flagged as requiring immediate action, or be flagged as general advice to the meet pre-determined objectives. The summary can display the number of advice that require immediate action and the number of advice that relates to meeting pre-determined objectives.

Below the summary, the advice screen can display the advice 146 and 148. As shown in FIG. 7, examples of advice that require immediate attention include advice to address wait times and advice to address food quality. Also shown in FIG. 7, examples of advice that meet pre-determined objectives include delivering a pep talk to the staff, or team, and making recommendations to the staff, or team.

As shown in FIG. 7, more than one advice can be flagged within a single category such as immediate action. However, the advice screen 140 displays the advice in a particular order. In the example shown in FIG. 7, the processor 18 has determined that advice to address wait times has a higher priority than advice to address food quality. Accordingly, the organization feedback application displays enhanced alerts for the advice to address wait times compared to the alerts used to display advice to address food quality. In FIG. 7, the enhanced alerts relate to the order in which the advice in displayed, that is, from top to bottom. In some embodiments, enhanced alerts can relate to audio and/or visual cues such as different sounds, animation, and/or colors.

The advice screen 140 can include a link to information about advice 144, similar to the link to information about alerts 132 in the alerts screen 130.

FIG. 7A shows another example advice screen 140A.

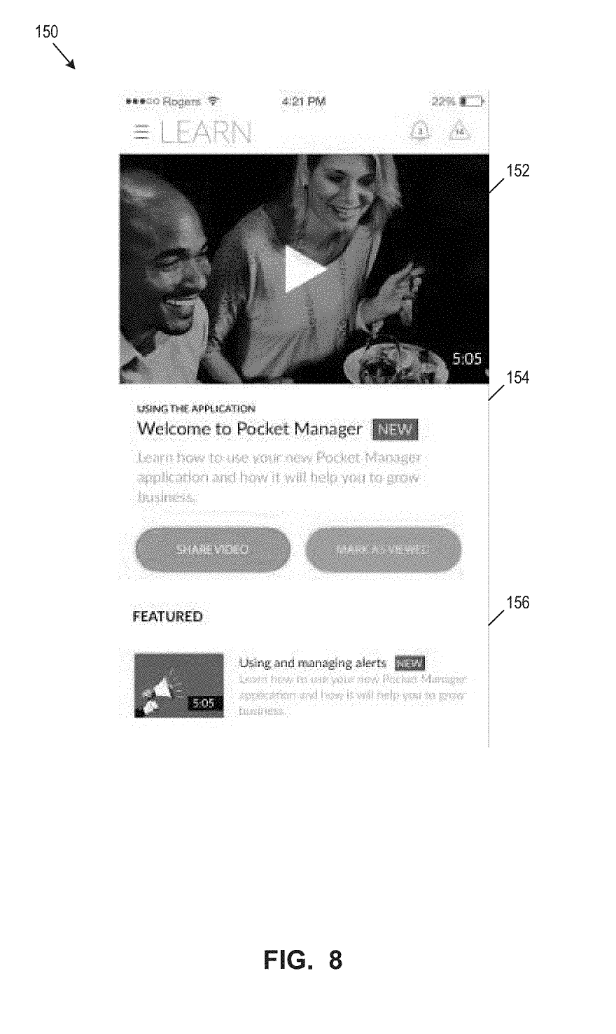

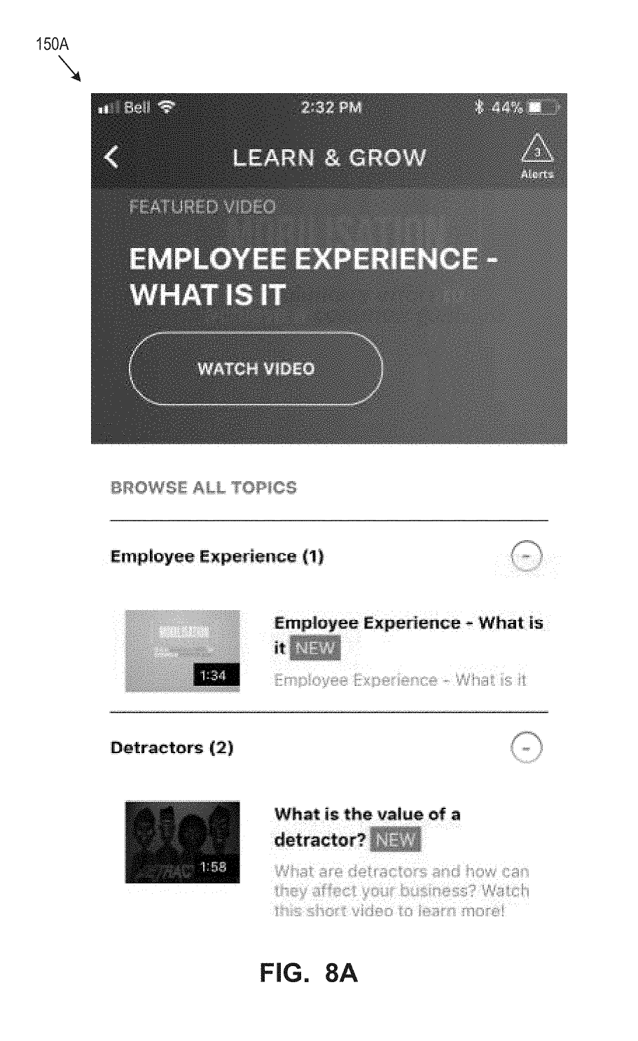

FIG. 8 shows a training or “learn & grow” screen 150. The training screen 150 can provide training content 152 in various forms, including text (e.g., articles), images, and video. Training content can be in-house training content that is provided by the organization and only available to the organization. Training content can also be general training content that is available to other organizations as well.

As shown in the training screen 150, training content 152 can include an introductory video to the organization feedback application. The training screen can also include options 154 to share the training content or mark the training content as having been reviewed. The training screen 150 can also provide links 156 to access additional training content.

The availability of training content within the organization feedback application can allow users to develop knowledge and abilities. In addition, such training content can facilitate real-time, on the job training.

FIG. 8 shows another training screen 150A.

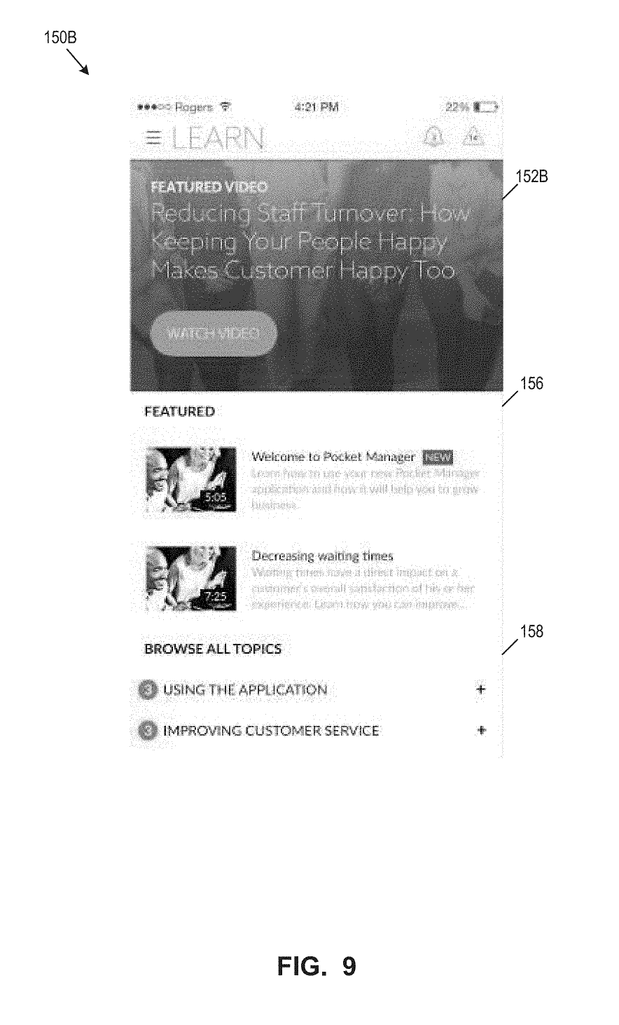

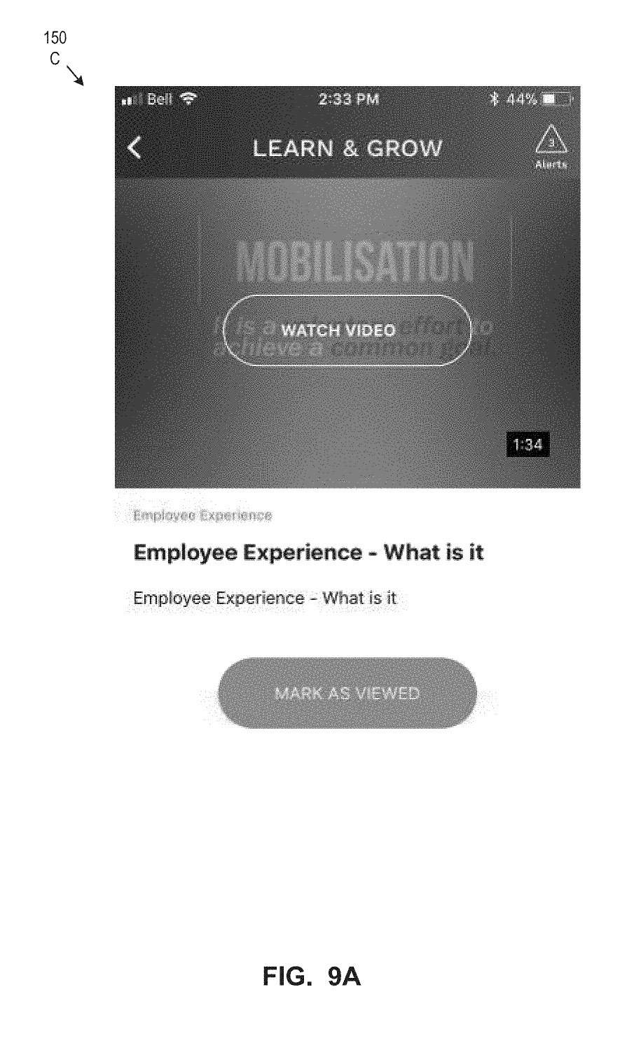

FIG. 9 shows another training screen 150B. The training screen 150B display different training content 152B from the training content 152 of training screen 150. The training content 152 and 152B may change, depending on the training content that has been completed. For example, the training content 152B may be displayed after the training content 152 has been completed. Training screen 150B can provide links 156 and 158 to access additional training content. Training content accessible by links 156 relate to training content recommended by the organization feedback application. The processor 18 can identify recommended training content based on the electronic patron feedback stored in the main feedback database 38 and/or the organization feedback database 20. In contrast, links 158 provide a directory of training content that the user may navigate on their own.

FIG. 9A shows another training screen 150C.

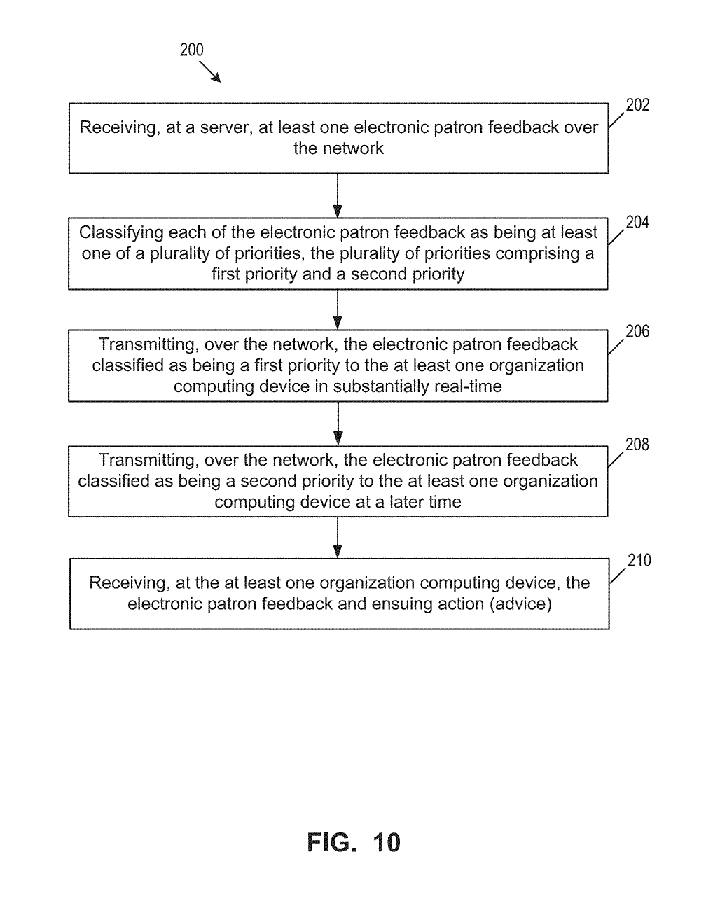

Referring now to FIG. 10, illustrated therein is a method 200 for providing electronic patron feedback over a network to at least one organization computing device, according to at least one embodiment. The method 200 can include, at step 202, when a server receives at least one electronic patron feedback over the network.

At step 204, the server can classify each of the electronic patron feedback as being at least one of a plurality of priorities. The plurality of priorities can include a first priority and a second priority. If electronic patron feedback is classified as being a first priority, at step 206, the server can transmit the electronic patron feedback to at least one organization computing device in substantially real-time. By being transmitted in substantially real-time, a user at the organization computing device can provide immediate attention to the electronic patron feedback and take immediate action to address issues. The timeliness of such attention and action can improve patron satisfaction rates (i.e., patrons' perception of the organization), increase promotors, reduce detractors, and/or improve the performance of the organization.

If electronic patron feedback as classified as being a second priority, at step 208, the server can transmit the electronic patron feedback to the at least one organization computing device at a later time. The lack of real-time attention to electronic patron feedback classified as being a second priority generally may not reduce patron satisfaction rates, decrease promoters, increase detractors, nor reduce the performance of the organization.

At step 210, the at least one organization computing device can receive the electronic patron feedback. The at least one organization computing device can display the electronic patron feedback to a user of the organization computing device, and as appropriate an appropriate action or advice for responding.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A method of providing electronic patron feedback over a network to at least one organization computing device, the method comprising:
a) receiving, at a server, at least one electronic patron feedback over the network, the server comprising a processor and a memory, wherein the processor is configured for:
i) classifying each of the electronic patron feedback as being at least one of a plurality of priorities, the plurality of priorities comprising a first priority and a second priority;
ii) transmitting, over the network, the electronic patron feedback classified as being a first priority to the at least one organization computing device in substantially real-time; and
b) receiving, at the at least one organization computing device, the electronic patron feedback, the at least one organization computing device comprising a user interface for providing the electronic patron feedback to a user of the at least one organization computing device.

2. The method of claim 1, wherein the processor is further configured for transmitting, over the network, the electronic patron feedback classified as being a second priority to the at least one organization computing device at a later time.

3. The method of claim 1 or claim 2, wherein the transmitting, over the network, the electronic patron feedback classified as being a first priority to the at least one organization computing device in substantially real-time further comprises for each electronic patron feedback classified as being a first priority, transmitting a corrective action recommendation responsive to that electronic patron feedback.

4. The method of claim 3, wherein the transmitting a corrective action recommendation responsive to that electronic patron feedback comprises:
a) accessing a database storing a plurality of corrective actions, each of the plurality of corrective actions being related to at least one pre-determined feedback; and
b) identifying a corrective action recommendation from the plurality of corrective actions based on the at least one pre-determined feedback of the corrective action recommendation being similar to that electronic patron feedback classified as being a first priority.

5. The method of any preceding claim, wherein:
a) the receiving, at a server, at least one electronic patron feedback over the network further comprises, for each electronic patron feedback, receiving patron data corresponding to that electronic patron feedback; and
b) the processor is further configured for:
i) comparing the patron data to a plurality of verified patron data;
ii) determining whether the electronic patron feedback is valid based on whether the corresponding patron data matches at least one of the plurality of verified patron data.

6. The method of claim 5, further comprising, if the electronic patron feedback is valid, storing the electronic patron feedback in a main database.

7. The method of claim 5 or claim 6, wherein:
a) the receiving, at a server, at least one electronic patron feedback over the network further comprises, for each electronic patron feedback:
i) providing a timestamp; and
ii) storing the electronic patron feedback and timestamp in a staging database; and
b) the determining whether the electronic patron feedback is valid based on whether the corresponding patron data matches at least one of the plurality of verified patron data further comprises:
i) determining whether the electronic patron feedback is substantially similar to other electronic patron feedback stored in the staging database;
ii) determining whether the timestamp of the electronic patron feedback is substantially similar to the timestamp of the other electronic patron feedback;
iii) determining a tally of the other electronic patron feedback that is substantially similar to the electronic patron feedback and has a substantially similar timestamp; and
iv) if the tally exceeds a pre-determined threshold indicative of invalid feedback, determining that the electronic patron feedback is invalid;
v) otherwise, determining that the electronic patron feedback is valid.

8. The method of claim 7, wherein the timestamp of the electronic patron feedback is substantially similar if it is within about ten seconds of the timestamp of the other electronic patron feedback.

9. The method of claim 8, wherein the timestamp of the electronic patron feedback is substantially similar if it is within about five seconds of the timestamp of the other electronic patron feedback.

10. The method of any one of claims 7 to 9, wherein the pre-determined threshold indicative of invalid feedback comprises a value of about 1000.

11. The method of any one of claims 7 to 9, wherein the pre-determined threshold indicative of invalid feedback comprises a value of about 2000.

12. The method of any preceding claim, wherein:
a) the electronic patron feedback comprises free form text; and
b) the classifying each of the electronic patron feedback as being at least one of a plurality of priorities comprises, for each electronic patron feedback:
i) parsing the electronic patron feedback to identify patron keywords;
ii) comparing the patron keywords to a set of first priority keywords; and
iii) if the patron keywords match the set of first priority keywords, classifying the electronic patron feedback as being the first priority.

13. The method of any preceding claim, wherein:
a) the electronic patron feedback comprises a rating selection from a plurality of rating options, each of the plurality of rating options being classified as one of the plurality of priorities; and
b) the classifying each of the electronic patron feedback as being at least one of a plurality of priorities comprises, for each electronic patron feedback:
i) if the rating selection is classified as the first priority, classifying the electronic patron feedback as being the first priority; and
ii) if the rating selection is classified as the second priority, classifying the electronic patron feedback as being the second priority.

14. The method of any preceding claim, wherein:
a) the at least one electronic patron feedback comprises a first electronic patron feedback and a second electronic patron feedback, each of the first electronic patron feedback and the second electronic patron feedback are classified as being a first priority; and
b) the method further comprises determining which of the first electronic patron feedback and the second electronic patron feedback to provide to the user with enhanced alerts.

15. The method of any preceding claim, wherein:
a) the first electronic patron feedback is received from a first patron computing device; and
b) the method further comprises:
i) receiving, at the server, a message responsive to the first electronic patron feedback sent from the at least one organization computing device over the network;
ii) transmitting, over the network, the message to the first patron computing device; and
iii) receiving, at the first patron computing device, the message sent from over the network, the first patron computing device comprising a user interface for providing the message to the first patron.

16. The method of any preceding claim, further comprising providing a patron feedback application to the first patron computing device for installation on the first patron computing device.

17. The method of any preceding claim, further comprising providing an organization feedback application to the at least one organization computing device for installation on the at least one organization computing device.

18. A system for providing electronic patron feedback over a network to at least one organization computing device, the system comprising a processor and a memory, wherein the processor is configured for:
a) receiving the electronic patron feedback over the network, the electronic patron feedback comprising at least one electronic patron feedback;
b) classifying each of the electronic patron feedback as being at least one of a plurality of priorities, the plurality of priorities comprising a first priority and a second priority; and
c) transmitting, over the network, the electronic patron feedback classified as being a first priority to the at least one organization computing device in substantially real-time;
d) wherein the at least one organization computing device comprises a user interface for providing the electronic patron feedback to a user of the at least one organization computing device.

19. The system of claim 18 wherein the processor is further configured for transmitting, over the network, the electronic patron feedback classified as being a second priority to the at least one organization computing device at a later time.

20. The system of claim 18 or 19 wherein the transmitting, over the network, the electronic patron feedback classified as being a first priority to the at least one organization computing device in substantially real-time further comprises transmitting a corrective action recommendation responsive to that electronic patron feedback.

21. The system of claim 20, wherein:
a) the system further comprises a corrective action database storing a plurality of corrective actions, each of the plurality of corrective actions being related to at least one pre-determined feedback; and
b) the transmitting a corrective action recommendation responsive to that electronic patron feedback comprises:
i) accessing the corrective action database; and
ii) identifying a corrective action recommendation from the plurality of corrective actions based on the at least one pre-determined feedback of the corrective action recommendation being similar to that electronic patron feedback classified as being a first priority.

22. The system of any one of claims 18 to 20, wherein:
a) the system further comprises a patron database for storing a plurality of verified patron data; and
b) the receiving the electronic patron feedback over the network further comprises, for each electronic patron feedback, receiving patron data corresponding to that electronic patron feedback; and
c) the processor is further configured for:
i) comparing the patron data to the plurality of verified patron data;
ii) determining whether the electronic patron feedback is valid based on whether the corresponding patron data matches at least one of the plurality of verified patron data.

23. The system of any one of claims 18 to 22, wherein:
a) the system further comprises a main database; and
b) the processor is further configured for, if the electronic patron feedback is valid, storing the electronic patron feedback in the main database.

24. The system of any one of claims 18 to 23, wherein:
a) the system further comprises a staging database storing other electronic patron feedback and timestamps; and
b) the receiving the electronic patron feedback over the network further comprises, for each electronic patron feedback:
i) providing a timestamp; and
ii) storing the electronic patron feedback and timestamp in the staging database; and
c) the determining whether the electronic patron feedback is valid based on whether the corresponding patron data matches at least one of the plurality of verified patron data further comprises:
i) determining whether the electronic patron feedback is substantially similar to the other electronic patron feedback;
ii) determining whether the timestamp of the electronic patron feedback is substantially similar to the timestamp of the other electronic patron feedback;
iii) determining a tally of the other electronic patron feedback that is substantially similar to the electronic patron feedback and has a substantially similar timestamp; and
iv) if the tally exceeds a pre-determined threshold indicative of invalid feedback, determining that the electronic patron feedback is invalid;
v) otherwise, determining that the electronic patron feedback is valid.

25. The system of claim 24, wherein the timestamp of the electronic patron feedback is substantially similar if it is within about ten seconds of the timestamp of the other electronic patron feedback.

26. The system of claim 25, wherein the timestamp of the electronic patron feedback is substantially similar if it is within about five seconds of the timestamp of the other electronic patron feedback.

27. The system of any one of claims 24 to 26, wherein the pre-determined threshold indicative of invalid feedback comprises a value of about 1000.

28. The system of any one of claims 24 to 26, wherein the pre-determined threshold indicative of invalid feedback comprises a value of about 2000.

29. The system of any one of claims 18 to 28, wherein:
a) the electronic patron feedback comprises free form text; and
b) the classifying each of the electronic patron feedback as being at least one of a plurality of priorities comprises, for each electronic patron feedback:
i) parsing the electronic patron feedback to identify patron keywords;
ii) comparing the patron keywords to a set of first priority keywords; and
iii) if the patron keywords match the set of first priority keywords, classifying the electronic patron feedback as being the first priority.

30. The system of any one of claims 18 to 29, wherein:
a) the electronic patron feedback comprises a rating selection from a plurality of rating options, each of the plurality of rating options being classified as one of the plurality of priorities; and
b) the classifying each of the electronic patron feedback as being at least one of a plurality of priorities comprises, for each electronic patron feedback:
i) if the rating selection is classified as the first priority, classifying the electronic patron feedback as being the first priority; and
ii) if the rating selection is classified as the second priority, classifying the electronic patron feedback as being the second priority.

31. The system of any one of claims 28 to 30, wherein:
a) the at least one electronic patron feedback comprises a first electronic patron feedback and a second electronic patron feedback, each of the first electronic patron feedback and the second electronic patron feedback are classified as being a first priority; and
b) the processor is further configured for determining which of the first electronic patron feedback and the second electronic patron feedback to provide to the user with enhanced alerts.

32. The system of any one of claims 18 to 31, wherein:
a) the first electronic patron feedback is received from a first patron computing device; and
b) the processor is further configured for:
i) receiving a message responsive to the electronic patron feedback sent from the at least one organization computing device over the network; and
ii) transmitting the message over the network to the first patron computing device, wherein the first patron computing device comprises a user interface for providing the message to the first patron.

33. The system of any one of claims 18 to 32, wherein the processor is further configured for transmitting a patron feedback application over the network to the first patron computing device for installation on the first patron computing device.

34. The system of any one of claims 18 to 33, wherein the processor is further configured for transmitting an organization feedback application over the network to the at least one organization computing device for installation on the at least one organization computing device.
